(19) United States
(12) Patent Application Publication
(10) Pub. No.: US 2021/0142768 A1
(43) Pub. Date: May 13, 2021

(54) DRUM

(71) Applicant: Marc Flipo, Brighton, VIC (AU)

(72) Inventor: Georgia Claire Flipo, Brighton (AU)

(21) Appl. No.: 16/626,038

(22) PCT Filed: Jun. 22, 2018
(86) PCT No.: PCT/AU2018/050634

§ 371 Date: Dec. 23, 2019

(30) Foreign Application Priority Data
Jun. 23, 2017 (AU) 2017902427
Feb. 6, 2018 (AU) 2018900363

(51) Int. Cl. G10D 13/02; G10D 13/10

(52) U.S. Cl. CPC G10D 13/02; G10D 13/26

(57) ABSTRACT

There is disclosed a drum including an impact surface, arranged to be struck such that the drum is beaten, and an electronic screen, the drum having electronic connectivity so as to be able to receive electronic signals such that an output of the screen is based on said signals.

### FIELD OF THE INVENTION

The present invention provides a drum having an electronic screen.

### BACKGROUND

Conventional bass drums have an impact surface arranged to be struck such that the drum is beaten to produce sound, and an opposite surface which typically faces an audience watching a performance in which the drum is being played. In the case of an acoustic bass drum, the opposite surface often functions as an acoustic membrane, which membrane can be opaque and bear logos such as the brand of the drum. The membrane can also be transparent such that an interior of the drum can be seen through the membrane. In the case of an electronic bass drum, the opposite surface is usually opaque and generally is not visually striking. In the case of both acoustic and electronic bass drums, there has been a limit as to how eye-catching such drums can appear to an audience, particularly the front face of the bass drum which faces the audience during a performance. As such, an audience is unlikely to pay much attention to, or be interested in, the appearance of a drum kit.

According to a first aspect of the invention, there is provided a drum including an impact surface, arranged to be struck such that the drum is beaten, and an electronic screen, the drum having electronic connectivity so as to be able to receive electronic signals such that an output of the screen is based on said signals.

The output of the screen can be dynamic and display a range of imagery which can make the drum more eye-catching and visually engaging to an audience.

In preferred embodiments of the invention, the drum has at least one data connector, e.g. a port, for receiving said signals via a wired connection, said connectivity thus comprising wired connectivity. For example, the data connector could be configured to connect to a corresponding connector of a wired input, such as an HDMI cable or DVI cable, or a VGA,USB or DisplayPort connector.

The drum can have a wireless receiver for receiving said signals wirelessly, said connectivity thus comprising wireless connectivity. Accordingly, the screen could receive signals wireless via any one of more of, for example, the Internet, Bluetooth, NFC, and so forth. For example, live video captured by a camera mounted in a Google Glass device could simultaneously be displayed as the output of the screen.

Preferably, the drum has opposite first and second ends, said impact surface is arranged at said first end and said screen is arranged at said second end, and the screen and impact surface face outwardly in opposite directions. Accordingly, the output of the screen can face outwardly and be seen by an audience. In preferred embodiments of the invention, the screen and impact surface are circular and substantially concentric.

In certain embodiments, the drum is an acoustic drum which comprises a shell and a taut membrane or drumhead which is supported from the shell and defines said impact surface. In such embodiments, the screen may be contained within said shell and/or secured to said shell. The drum can also comprise a membrane which overlies the screen at said second end, the membrane being configured such that the output of the screen can be seen therethrough. It is preferable for the screen to be adjacent this overlying membrane, such that the output appears to be from that membrane. To this end, it is also desirable for the screen to occupy substantially the entirety of an area of said second end, such that a frame of the screen can be concealed within the drum, by, for example, the drum hoop. In this way, the drum may appear “alive” to the audience because it is the audience-facing membrane itself which appears to be displaying the output of the screen, which output may, for example, be visually interesting and/or comprise dynamic imagery.

The membrane overlying the screen can also function as a shield which helps to protect the screen from impacts on the second end. For example, the overlying membrane could protect the screen against the impact of a beverage container hurled from an audience member. The membrane overlying the screen may also serve to improve or alter the acoustic characteristics of the drum, consistent with corresponding membranes in conventional drums.

In preferred embodiments of the invention, the drum is ventilated such that heat generated by the screen can escape from an interior of the drum. For example, the exterior of the drum can be configured with openings which function as vents through which heat can escape from the interior of the drum. Preferably, the shell of the drum is configured with such vents. To facilitate ventilation through the vents, the drum can include at least one fan or blower arranged to drive heat generated by the screen from the drum.

Preferably, the at least one fan or blower is arranged within the shell. In this way, electrical componentry of the drum, including the fan or blower itself, can be concealed within the interior of the drum such that the exterior thereof does not appear modified to an audience. This adds to the performative aspect that the drum is “alive” in that it does not appear to have been modified in order for its audience facing membrane to display imagery. Of course, having these cooling components within the shell can also contribute to ventilation performance. Preferably, the at least one fan or blower is arranged to drive heat generated by the screen through said vents.

An electronic drum is of course within the scope of this invention and thus the drum of the invention could be an electronic drum wherein the impact surface is defined by an electric drum pad. In this case, the screen can simply be secured to the exterior of the opposite surface of the electronic drum.

In preferred embodiments of the invention, the screen is an LED screen, though other types of screen are within the scope of the invention, such as LCD screens.

Preferably, the drum is a bass drum.

According to a second aspect of the invention, there is provided a system comprising:

a drum according to the first aspect of the invention; and

an electronic source, connected to the drum and arranged to provide said signals to said drum.

The source can comprise a video camera, such that said output is a view from said camera. For example, the camera could be trained on an area that is occupied by an audience that is watching a performance in which the drum is being played, and the output would comprise a view of the audience from said camera. In this way, members of the audience can effectively view live footage of themselves on the screen.

The source can comprise a computer such that said output is based on signals received from the computer and which correspond with imagery stored on or streamed via the computer. For example, the computer could be streaming a video from the Internet, and signals corresponding to that video can be sent to the drum such that those signals form the basis of the output on the screen. Videos or still images can also be stored locally on the computer, and, via the electronic connectivity of the drum, be displayed as the output of the screen.

The drum or system can include a controller operable to control content and/or the timing of the output. The controller can be operable by a drummer stationed at the drum so as to control the output of the screen. For example, a selection of prerecorded videos could be stored on a computer connected to the drum, and the drummer would be able to select which of those videos played at a certain time. For example, one pre-recording could be a video of a cartoon face turning into a frown, and the drummer, after telling a bad joke during a performance, could, via operation of the controller, cause the screen to output the pre-recorded video of the face frowning. This can give the appearance that the drummer is interacting and engaging with the drum, which can be an entertaining spectacle to the audience. The drum could also be used in such a way to interact with the audience; the drummer could, for example, display the lyrics of a song on the screen while performing that very song such that the audience can sing along with the performance.

The drum or system according to the preferred embodiments of the invention includes a power source for powering the electronic screen. The power source can comprise a DC power source, such as a battery, which may be a part of the drum—e.g. contained within said shell, or additional to the drum. The power source can, alternatively or additionally, comprise an AC power source, e.g. a mains power source, to which the drum is connected. In a preferred embodiment of the invention, the fan(s)/blower(s) is/are arranged to be powered by the power source.

According to a third aspect of the invention, there is provided a method of operating a system according to the second aspect of the invention, comprising striking said impact surface to play the drum during the output from the screen.

The signals could relate to an event occurring during playing of the drum such that the output is based on the event. For example, during a live playing of the drums during New Year's Eve, the output of the screen could display live footage of New Year's Eve celebrations occurring elsewhere in the world.

### DRAWINGS

The invention will be described, by way of non-limiting example only, with reference to the accompanying figures, in which:

FIG. 1 shows a drum which includes an electronic screen which is turned off;

FIG. 2 shows the drum of FIG. 1 with the screen turned on;

FIG. 3 is an exploded view of a rim assembly to which the screen is securable; and

FIG. 4 is a cross-sectional view of the screen and rim of FIG. 3.

### DETAILED DESCRIPTION

FIGS. 1 and 2 show an acoustic bass drum 1 including a rear impact surface 2 (see FIG. 4) arranged to be struck via a foot pedal to produce sound. The drum 1 also includes an LCD screen 3 and has electronic connectivity for receiving electronic signals such that an output of the screen 3 is based on those signals. For example, the drum 1 can have at least one data port 7A for receiving said signals via a wired connection, comprising, for example, an HDMI cable and/or USB cable. In FIG. 2, the screen 3 is shown connected to a computer via such a cable 20A plugged into port 7A, the output of the screen in the particular example shown being a static image corresponding to an image stored on the computer.

With reference to FIG. 4, the impact surface 2 is arranged at a first end 4 of the drum 1, and the screen 3 is arranged towards an opposing second end 5, with the screen 3 and the impact surface 2 facing outwardly in opposite directions. Accordingly, the output of the screen 3 can face outwardly and be seen by an audience.

Referring back to FIGS. 1 and 2, the acoustic drum 1 comprises a shell 6, with the impact surface 2 being defined by a drumhead (not shown) supported from the shell 6. An acoustic membrane 8 is arranged at the second end 5 of the drum 1.

The screen 3 is contained within the shell 6 between the drumhead and the membrane 8, and is arranged such that the screen 3 is adjacent, and almost flush with the membrane 8. This second end membrane 8 overlies the screen 3 and is configured such that the output of the screen 3 can be seen therethrough. In the depicted embodiment, this second end membrane 8 is substantially transparent, though it is of course possible for the membrane to have different levels of transparency/translucency to provide interesting visual effects. By arranging the screen 3 adjacent the overlying membrane 8 (see FIG. 4), the output from the screen 3 appears to project directly from the membrane 8, thereby giving the impression that the drum 1 is “alive” and is itself visually dynamic.

In the depicted acoustic bass drum 1, the screen 3 and the impact surface 2 are circular and substantially concentric, and the screen 3 occupies substantially the entirety of an area of said second end 5. As such, any frame that borders the screen 3 is concealed within the drum 1, and it appears as though the output of the screen 3 projects directly from the overlying second end membrane 8.

FIG. 3 shows an exploded view of a rim assembly 9 to which the screen 3 is=securable, the rim assembly 9 being securable at the second end 5 of the drum 1. The rim assembly 9 is configured with vents 10 (FIG. 4) such that heat generated by the screen 3 can escape from an interior of the drum 1. To this end, and with reference to FIG. 3, the rim assembly 9 includes a series of annular rings 11 comprising discrete openings 12 which, when the rings 11 are assembled and the openings 12 are aligned with one another, provide ventilation pathways 10 (see FIG. 4) for air to enter into and exit from the interior of the drum 1. A backing wall/face 13 of the rim assembly 9 carries two fans 14 arranged to drive heat generated by the screen 3 from the drum 1. With the rim assembly 9 attached to the drum shell 6, as seen in FIG. 4, the fans 14 are arranged within the shell 6 and work to suck cool air into the interior of the drum 1 while facilitating the escape of warmer air out therefrom, via the ventilation pathways 10.

The drum 1 includes a power socket to receive a power plug on a mains power cable 20B for powering the screen 3 and fans 14.

Other drums with different configurations, dimensions and geometries can, without departure from the invention, be provided, the drums having correspondingly sized and shaped electronic screens. Additionally, it is acknowledged that drum membranes may include openings to allow air to escape for shorter sustain; the term “membrane” used throughout this specification is intended to include such drum membranes. Also possible without departure from the invention are drums in which the screen defines the exterior face of the drum at the second end (instead of being arranged behind a membrane).

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

1. A drum including an impact surface, arranged to be struck such that the drum is beaten, and an electronic screen, the drum having electronic connectivity so as to be able to receive electronic signals such that an output of the screen is based on said signals.

2. A drum according to claim 1, having at least one data connector for receiving said signals via a wired connection, said connectivity thus comprising wired connectivity.

3. A drum according to claim 1, having a wireless receiver for receiving said signals wirelessly, said connectivity thus comprising wireless connectivity.

4. A drum according to claim 1, having opposite first and second ends, wherein said impact surface is arranged at said first end and said screen is arranged at said second end, and wherein the screen and impact surface face outwardly in opposite directions.

5. A drum according to claim 1, wherein the screen and surface are circular and substantially concentric.

6. A drum according to claim 4, wherein the screen occupies substantially the entirety of an area of said second end.

7. A drum according to claim 1, being an acoustic drum comprising a shell and a taut membrane or drumhead which is supported from the shell and defines said impact surface.

8. A drum according to claim 7, wherein the screen is contained within said shell and/or secured to said shell.

9. A drum according to claim 7, comprising an acoustic membrane which overlies the screen at said second end and through which the output can be seen.

10. A drum according to claim 9, wherein the screen is adjacent the membrane overlying it, such that the output appears to be from that membrane.

11. (canceled)

12. (canceled)

13. A drum according to claim 1, said drum being ventilated such that heat generated by the screen can escape from an interior of the drum.

14. (canceled)

15. (canceled)

16. A drum according to claim 1, including a fan or blower arranged to drive heat generated by the screen from said drum.

17. (canceled)

18. (canceled)

19. A drum according to claim 1, being an electronic drum comprising an electric drum pad which defines said impact surface.

20. A drum according to claim 1, wherein the screen is an LED screen.

21. A drum according to claim 1, being a bass drum.

22. A system comprising:
a drum according to claim 1; and
an electronic source connected to the drum and arranged to provide said signals to said drum.

23. (canceled)

24. (canceled)

25. A system according to claim 22, wherein said source comprises a computer.

26. A system according to claim 22, further comprising a controller operable to control content and/or timing of the output.

27. A system according to claim 26, wherein the controller is arranged to be operable by a drummer stationed at the drum.

28. A method of operating a system according to claim 22, comprising striking said impact surface to play the drum during the output from the screen.

29. (canceled)
